(19) United States
(12) Patent Application Publication
(10) Pub. No.: US 2025/0364682 A1
(43) Pub. Date: Nov. 27, 2025

(54) BATTERY PACK

(71) Applicants: HYUNDAI MOTOR COMPANY, Seoul (KR); Kia Corporation, Seoul (KR)

(72) Inventors: Kyung Mo KIM, Hwaseong-si (KR); Jong Gyu PARK, Hwaseong-si (KR); Gun Woo KO, Hwaseong-si (KR); Chan Sol KIM, Hwaseong-si (KR)

(73) Assignees: HYUNDAI MOTOR COMPANY, Seoul (KR); Kia Corporation, Seoul (KR)

(21) Appl. No.: 18/970,524

(22) Filed: Dec. 5, 2024

(30) Foreign Application Priority Data
May 24, 2024 (KR) 10-2024-0068051

(51) Int. Cl. H01M 50/383; H01M 10/613; H01M 10/647; H01M 10/656; H01M 50/209; H01M 50/262; H01M 50/271; H01M 50/293; H01M 50/30; H01M 50/358

(52) U.S. Cl. CPC H01M 50/383; H01M 10/613; H01M 10/647; H01M 10/656; H01M 50/209; H01M 50/262; H01M 50/271; H01M 50/293; H01M 50/358; H01M 50/394

(57) ABSTRACT

A battery pack includes a battery housing with a crossing member that defines an accommodation space and a base plate in contact with the crossing member. A plurality of cell stacks are mounted within the accommodation space, positioned to face each other with the crossing member interposed between them. The crossing member includes a venting passage in communication with the cell stacks and a partition wall that divides the venting passage in a second direction within the crossing member. The cell stacks consist of multiple first cell stacks arranged on one side of the base plate in a third direction intersecting the second direction and multiple second cell stacks arranged on the opposite side of the base plate in the third direction.

### CROSS-REFERENCE TO RELATED APPLICATION

This application claims the benefit of priority to Korean Patent Application No. 10-2024-0068051, filed in the Korean Intellectual Property Office on May 24, 2024, the entire contents of which are incorporated herein by reference.

### TECHNICAL FIELD

The present disclosure relates to a battery pack.

### BACKGROUND

Recently, as awareness of environmental crises and the depletion of petroleum resources has increased, research and development on electric vehicles, which are eco-friendly, has gained attention. Electric vehicles include a plug-in hybrid electric vehicle (PHEV), a battery electric vehicle (BEV), and a fuel cell electric vehicle (FCEV).

An electric vehicle may include a battery housing that supports battery cells. Electric vehicles use battery cells as a power source, and recent efforts have focused on increasing the capacity of battery cells housed within the battery housing.

To improve the capacity of battery cells, battery cells may be accommodated in the interior of the battery housing in the form of cell to pack (CTP) rather than in module form. When mounted in the CTP format, the battery cells may be arranged as a cell stack. As a result, a need for a structure, in which the lead part of the cell stack and a busbar are easily coupled to each other, is increasing.

### SUMMARY

The present disclosure aims to solve the aforementioned problems in the prior art while preserving the advantages achieved by it.

An aspect of the present disclosure provides a battery pack with a structure that allows for thermal delay of cell stacks while preventing thermal runaway.

The technical problems addressed by the present disclosure are not limited to the aforementioned problems, and any other technical problems not mentioned will become clear from the following description to those skilled in the art.

According to an aspect of the present disclosure, a battery pack includes a battery housing comprising a crossing member that defines an accommodation space and extends in a first direction to divide the accommodation space, and a base plate that contacts the crossing member, and a plurality of cell stacks mounted in the accommodation space to face each other in a second direction intersecting the first direction with the crossing member being interposed between them, the crossing member further includes a venting passage coupled to the plurality of cell stacks and extending in the first direction, and a partition wall that extends in a third direction intersecting the second direction to divide the venting passage in the second direction, in an interior of the crossing member, and the plurality of cell stacks include a plurality of first cell stacks disposed on one side of the base plate in the third direction, and a plurality of second cell stacks disposed on an opposite side of the base plate in the third direction.

The battery pack may further include a first supporting frame positioned to support the plurality of first cell stacks and a second supporting frame positioned to support the plurality of second cell stacks.

At least a partial area of the first supporting frame may be positioned between the plurality of first cell stacks and the crossing member.

The first supporting frame may further include a communication hole configured to provide communication between the plurality of first cell stacks and the venting passage, and the communication hole may be located in an area of the first supporting frame between the plurality of first cell stacks and the crossing member.

The battery pack may further include a frame fixing member configured to secure the first supporting frame and the second supporting frame to the base plate, and the battery housing may further include a cross fixing member configured to receive the frame fixing member and configured to support the second supporting frame.

The battery pack may further include a first pack cover disposed on one side of the plurality of first cell stacks in the third direction, and a second pack cover disposed on an opposite side of the plurality of second cell stacks in the third direction, and the cross fixing member may be positioned between the second pack cover and the second supporting frame.

The first supporting frame may include a cell support area configured to support the plurality of first cell stacks, and a fixing area protruding from the cell support area in the second direction, and the fixing area configured to receive the frame fixing member.

The crossing member may include a first crossing member positioned on the one side of the base plate in the third direction, and disposed between the plurality of first cell stacks, and a second crossing member positioned on the opposite side of the base plate in the third direction, and disposed between the plurality of second cell stacks.

The plurality of first cell stacks may include a (1-1)-th cell stack disposed on one side of the first crossing member in the second direction, and a (1-2)-th cell stack disposed on an opposite side of the first crossing member in the second direction, the venting passage formed in an interior of the first crossing member may include a first venting area provided on one side of the partition wall in the second direction, and a second venting area provided on an opposite side of the partition wall in the second direction, and the first venting area may be communicated with the (1-1)-th cell stack, and the second venting area may be communicated with the (1-2)-th cell stack.

The battery pack may further include a first supporting frame configured to support the plurality of first cell stacks, and a second supporting frame configured to support the plurality of second cell stacks, the first supporting frame may include a (1-1)-th support frame area supporting the (1-1)-th cell stack, and a (1-2)-th support frame area supporting the (1-2)-th cell stack, and the (1-1)-th supporting frame may further include a communication hole configured to provide communication between the (1-1)-th cell stack and a first venting passage, and the first crossing member may further include a venting hole formed in an area facing the communication hole.

The base plate may further include a cooling channel formed in its interior.

The base plate may be coupled to both the first crossing member and the second crossing member to secure the first crossing member and the second crossing member in position.

At least one of the first pack cover or the second pack cover may further include a cooling channel formed within its interior.

The battery housing may further include a front member disposed on one side of the accommodation space in the second direction or a rear member disposed on an opposite side of the accommodation space in the second direction, and the front member or the rear member may be coupled to the first pack cover and the second pack cover.

The partition wall may be formed of steel or mica, and a remaining area of the crossing member, except for the partition wall, may be formed of aluminum (Al).

The battery pack may further include a venting device mounted on one end of the venting passage in the first direction.

### BRIEF DESCRIPTION OF THE DRAWINGS

The above and other objects, features, and advantages of the present disclosure will become more apparent from the following detailed description taken in conjunction with the accompanying drawings:

FIG. 1 is an exploded perspective view of a battery pack according to an embodiment of the present disclosure;

FIG. 2 is a vertical cross-sectional view of a battery pack according to an embodiment of the present disclosure;

FIGS. 3 to 7 are schematic views sequentially illustrating a state, in which a first cell stack and a second cell stack are mounted on a battery housing according to an embodiment of the present disclosure;

FIG. 8 is a schematic view illustrating the flow of flame or gas through a venting passage when a fire occurs in cell stacks that face each other with a crossing member interposed between them, according to an embodiment of the present disclosure;

FIG. 9 is an enlarged view of a venting device that is mounted on a battery housing according to an embodiment of the present disclosure;

FIG. 10A is a perspective view of a first cell stack that is mounted on a first supporting frame according to an embodiment of the present disclosure;

FIG. 10B is a perspective view of a second cell stack that is mounted on a second supporting frame according to an embodiment of the present disclosure;

FIGS. 11 to 17 are perspective views sequentially illustrating a process of manufacturing a second cell stack according to an embodiment of the present disclosure; and

FIG. 18 is a flowchart illustrating a method for manufacturing a cell stack according to an embodiment of the present disclosure.

### DETAILED DESCRIPTION

Hereinafter, embodiments of the present disclosure will be described in detail with reference to the accompanying drawings. When adding reference numerals to the components of the drawings, it is noted that the same components are denoted by the same reference numerals, even when they are drawn in different drawings. Furthermore, if a detailed description of related known configurations and functions is deemed to hinder understanding of the embodiments of the present disclosure, it will be omitted.

Furthermore, in describing the components of the embodiments of the present disclosure, terms, such as first, second, “A”, “B”, (a), and (b) may be used. The terms are used solely to distinguish the components, and the essence, sequence, and order of the corresponding components are not limited by the terms. Unless otherwise defined, all terms, including technical and scientific terms, used herein have the same meaning as commonly understood by those skilled in the art to which the present disclosure pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

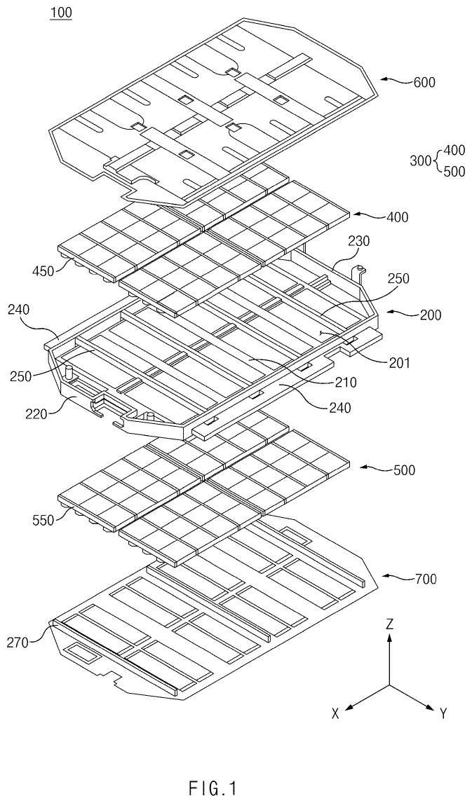

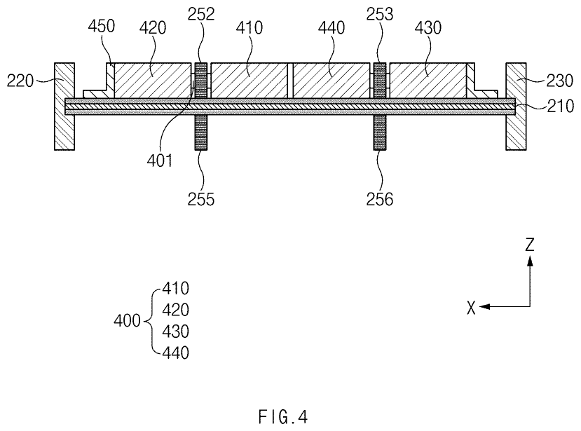

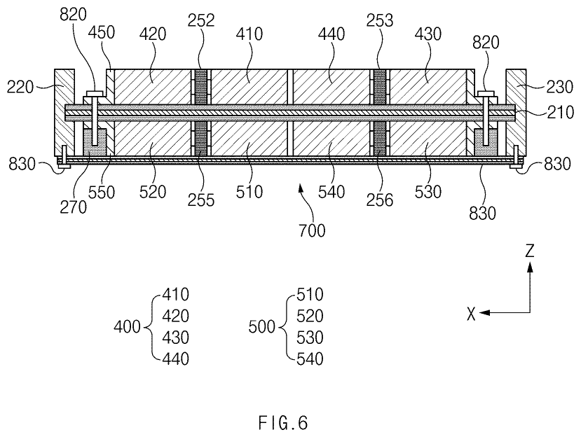

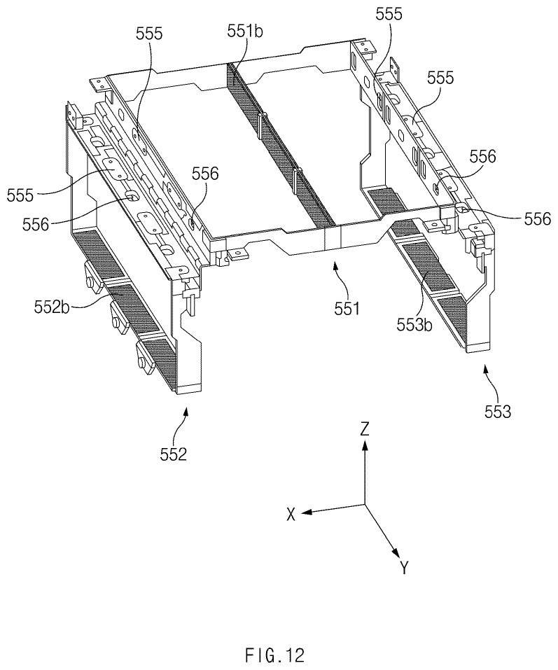

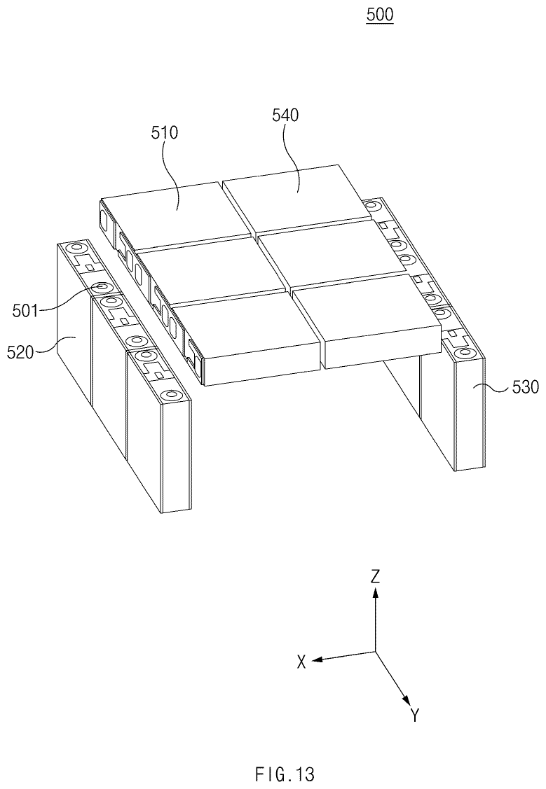

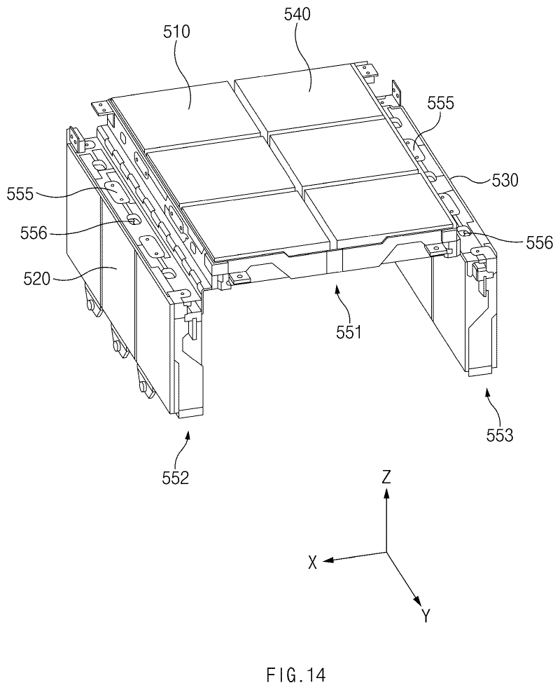

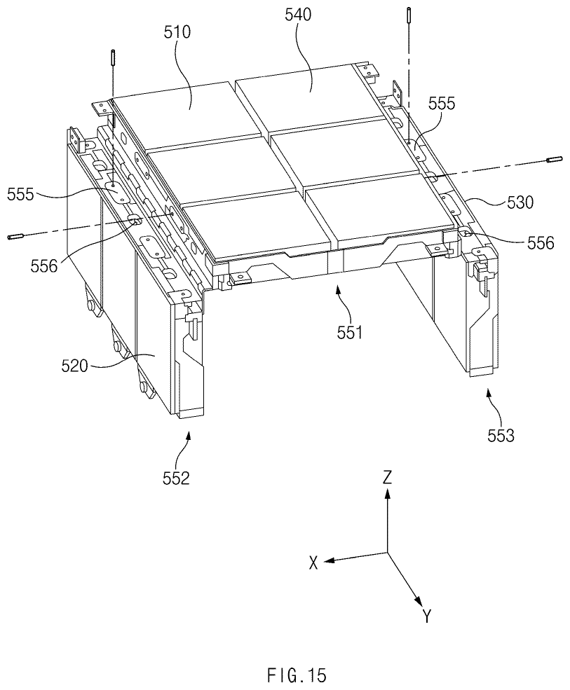

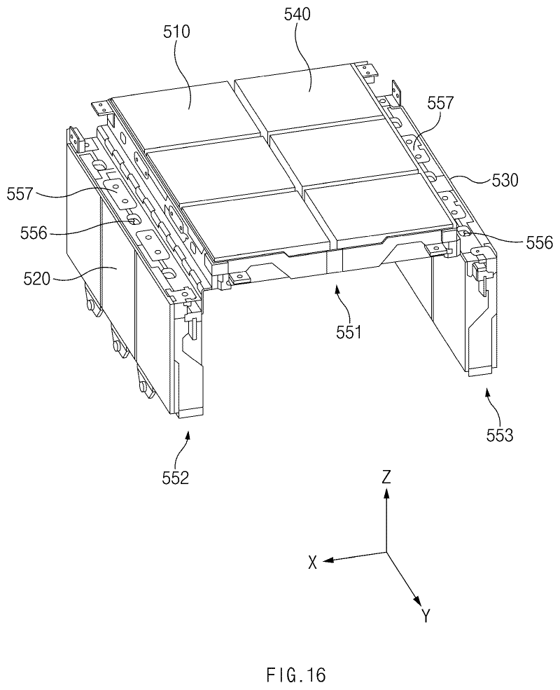

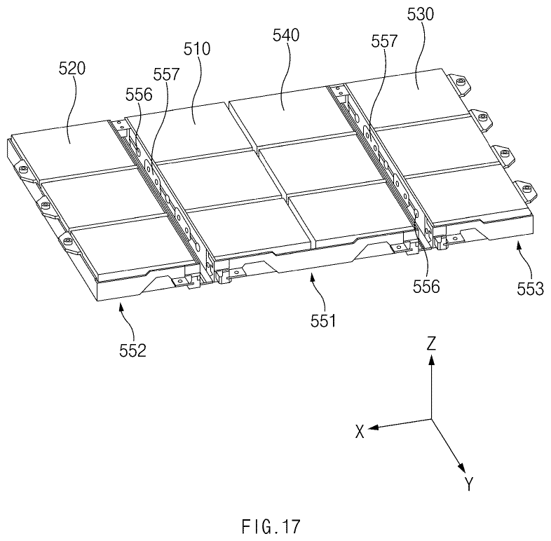

Hereinafter, embodiments of the present disclosure will be described in detail with reference to FIGS. 1 to 18. In the following, the leftward/rightward direction may be referred to as the first direction, the forward/rearward direction as the second direction, and the upward/downward direction as the third direction.

FIG. 1 is an exploded perspective view of a battery pack according to an embodiment of the present disclosure.

Referring to FIG. 1, a battery pack 100 may include a battery housing 200, a plurality of cell stacks 300 mounted on the battery housing 200, and first and second pack covers 600 and 700.

The battery housing 200 may define an accommodation space 201, in which the plurality of cell stacks 300 are housed. The battery housing 200 may include a base plate 210 that contacts the plurality of cell stacks 300, and a crossing member 250 that contacts the base plate 210 and extends in a leftward/rightward direction (the “Y” direction or an opposite direction to the “Y” direction) to divide the accommodation space 201. Here, the leftward/rightward direction may be a first direction.

The crossing members 250 may be disposed to be spaced apart from each other along a forward/rearward direction (the “X” direction or an opposite direction to the “X” direction). Here, the forward/rearward direction may be a second direction. Crossing members 250 may be disposed on opposite sides of the base plate 210 in the upward/downward direction (the “Z” direction or its opposite). Here, the up/downward direction may be a third direction.

The battery housing 200 may include a front member 220 that covers a front (the “X” direction) area of the accommodation space 201, and a rear member 230 covering a rear area (an opposite direction to the “X” direction) of the accommodation space 201.

The front member 220 and the rear member 230 may not be provided only on an upper side of the base plate 210, but may be disposed in both the upper and lower areas of the base plate 210 in the front and rear areas of the base plate 210.

The battery housing 200 may include a side member 240 that extends in the forward/rearward direction while connecting the front member 220 and the rear member 230, and covers a left or right area of the accommodation space 201. A pair of side members 240 may be provided on opposite sides of the accommodation space 201 in the leftward/rightward direction. Each of the pair of side members 240 may cover opposite side areas of the plurality of cell stacks 300 in the leftward/rightward direction.

The plurality of cell stacks 300 may be mounted in the accommodation space 201 facing each other in the forward/rearward direction with the crossing member 250 being interposed between them. The plurality of cell stacks 300 may be disposed such that the plurality of cells face each other toward the crossing member 250. Here, the cells of the plurality of cell stacks 300 may be angular battery cells, but are not limited thereto. Supporting frames 450 and 550 for supporting the plurality of cell stacks 300 may be provided in the plurality of cell stacks 300.

The plurality of cell stacks 300 may include a plurality of first cell stacks 400 disposed on an upper side of the base plate 210 and a plurality of second cell stacks 500 disposed on a lower side of the base plate 210.

The supporting frames 450 and 550 may include a first supporting frame 450 supporting a plurality of first cell stacks 400 and a second supporting frame 550 supporting a plurality of second cell stacks 500.

A first pack cover 600 may be disposed on an upper side of the plurality of first cell stacks 400 to cover their upper area. A second pack cover 700 may be disposed on a lower side of the plurality of second cell stacks 500 to cover their lower area.

Meanwhile, the battery housing 200 may further include a cross fixing member 270 disposed between the second pack cover 700 and the base plate 210. A plurality of cross fixing members 270 may extend in the leftward/rightward direction and spaced apart from each other in the forward/rearward direction. The cross fixing member 270 may be a member for fixing the plurality of first cell stacks 400 and the plurality of second cell stacks 500 together to the base plate 210.

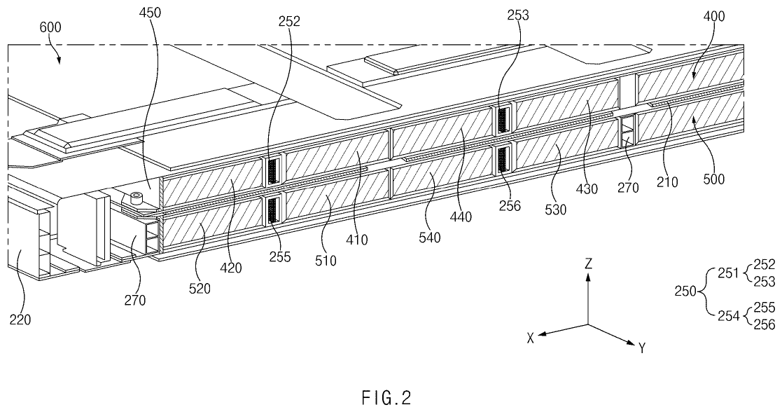

FIG. 2 is a vertical cross-sectional view of a battery pack according to an embodiment of the present disclosure.

Referring to FIG. 2, the crossing member 250 may include a first crossing member 251 disposed on an upper side of the base plate 210 between the plurality of first cell stacks 400 and a second crossing member 254 disposed on a lower side of the base plate 210 between the plurality of second cell stacks 500.

The first crossing member 251 may include a (1-1)-th crossing member 252 and a (1-2)-th crossing member 253 disposed on a rear side of the (1-1)-th crossing member 252. The (1-1)-th crossing member 252 and the (1-2)-th crossing member 253 may be spaced apart from each other in the forward/rearward direction. Here, the rear side may be one side in the second direction, and the front side may be an opposite side in the second direction.

The second crossing member 254 may include a (2-1)-th crossing member 255, and a (2-2)-th crossing member 256 disposed on the rear side of the (2-1)-th crossing member 255. The (2-1)-th crossing member 255 and the (2-2)-th crossing member 256 may be spaced apart from each other in the forward/rearward direction.

The plurality of first cell stacks 400 may include a (1-1)-th cell stack 410 that is disposed on a rear side of the (1-1)-th crossing member 252, a (1-2)-th cell stack 420 disposed on a front side of the (1-1)-th crossing member 252, a (1-3)-th cell stack 430 disposed on a rear side of the (1-2)-th crossing member 253, and a (1-4)-th cell stack 440 disposed on a front side of the (1-2)-th crossing member 253.

The plurality of second cell stacks 500 may include a (2-1)-th cell stack 510 disposed on a rear side of the (2-1)-th crossing member 255, a (2-2)-th cell stack 520 disposed on a front side of the (2-1)-th crossing member 255, a (2-3)-th cell stack 530 disposed on a rear side of the (2-2)-th crossing member 256, and a (2-4)-th cell stack 540 disposed on a front side of the (2-2)-th crossing member 256.

Then, the (1-2)-th cell stack 420 and the (2-2)-th cell stack 520 may be disposed between the front member 220 and the (1-1)-th crossing member 252, and between the front member 220 and the (2-1)-th crossing member 255, respectively.

Furthermore, the (1-1)-th cell stack 410 and the (1-4)-th cell stack 440 may be disposed between the (1-1)-th crossing member 252 and the (1-2)-th crossing member 253, and the (2-1)-th cell stack 510 and the (2-4)-th cell stack 540 may be disposed between the (2-1)-th crossing member 255 and the (2-2)-th crossing member 256.

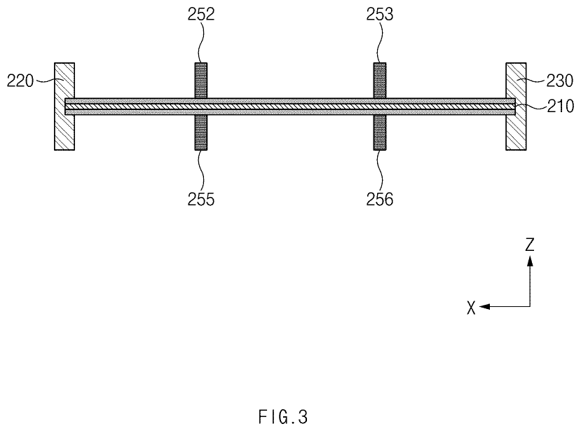

FIGS. 3 to 7 are schematic views sequentially illustrating a state in which a first cell stack and a second cell stack are mounted on a battery housing according to an embodiment of the present disclosure.

Referring to FIGS. 3 to 7, a first cell stack 400 and a second cell stack 500 may be sequentially mounted in an interior of the accommodation space 201 (see FIG. 1). However, in FIGS. 3 to 7, it is illustrated that the first cell stack 400 and the second cell stack 500 are mounted between the front member 220 and the rear member 230, but the present disclosure is not limited thereto, and a plurality of first cell stacks 400 and a plurality of second cell stacks 500 may be inserted between the front member 220 and the rear member 230.

The front member 220, the rear member 230, and the (1-1)-th, (1-2)-th, (2-1)-th and (2-2)-th crossing members 252, 253, 255, and 256 may be mounted on the base plate 210. The base plate 210 may be coupled to the front member 220, the rear member 230, and the (1-1)-th, (1-2)-th, (2-1)-th, and (2-2)-th crossing members 252, 253, 255, and 256 to secure them in place.

The first cell stack 400 and the first supporting frame 450 may be mounted on an upper side of the base plate 210. The (1-1)-th crossing member 252 may be disposed between the (1-1)-th cell stack 410 and the (1-2)-th cell stack 420, and the (1-2)-th crossing member 253 may be disposed between the (1-3)-th cell stack 430 and the (1-4)-th cell stack 440.

Then, the lead parts 401 of the (1-1)-th cell stack 410 and the (1-2)-th cell stack 420 may be formed to protrude toward each other with the (1-1)-th crossing member 252 being interposed between them. Furthermore, the lead parts 401 of the (1-3)-th cell stack 430 and the (1-4)-th cell stack 440 may be formed to protrude toward each other with the (1-2)-th crossing member 253 being interposed between them.

At least a portion of the first supporting frame 450 may be provided between the plurality of first cell stacks 400 and the first crossing member 251. An area between the plurality of first cell stacks 400 of the first supporting frame 450 and the first crossing member 251 may be part of a rotating area of the first supporting frame 450.

When the first cell stack 400 is mounted in the accommodation space 201 in contact with the base plate 210, the second cell stack 500 may be mounted on a lower side of the base plate 210. The (2-1)-th crossing member 255 may be positioned between the (2-1)-th cell stack 510 and the (2-2)-th cell stack 520, and the (2-2)-th crossing member 256 may be positioned between the (2-3)-th cell stack 530 and the (2-4)-th cell stack 540.

Then, the lead parts 501 of the (2-1)-th cell stack 510 and the (2-2)-th cell stack 520 may protrude toward each other with the (2-1)-th crossing member 255 being interposed between them. Furthermore, the lead parts 501 of the (2-3)-th cell stack 530 and the (2-4)-th cell stack 540 may protrude toward each other with the (2-2)-th crossing member 256 being interposed between them.

At least a portion of the second supporting frame 550 may be positioned between the plurality of second cell stacks 500 and the second crossing member 254. An area between the plurality of second cell stacks 500 of the second supporting frame 550 and the second crossing member 254 may be part of a rotating area of the second supporting frame 550.

When the second cell stack 500 is disposed on a lower side of the base plate 210, a fixing member 810 for fixing the first supporting frame 450 and the second supporting frame 550 to the base plate 210 may be inserted into the first supporting frame 450, the base plate 210, and the second supporting frame 550.

Thus, a battery pack 100 (see FIG. 1) may further include a fixing member 810 designed to secure the first supporting frame 450 and the second supporting frame 550 to the base plate 210.

In more detail, the first supporting frame 450 may include a first cell supporting area that supports the (1-2)-th cell stack 420 and the (1-3)-th cell stack 430 and a first fixing area that protrudes from the first cell supporting area in forward/rearward direction and contacts the base plate 210. Similarly, the second supporting frame 550 may include a second cell supporting area supporting the (2-2)-th cell stack 520 and the (2-3)-th cell stack 530 and a second fixing area that protrudes from the second cell supporting area in forward/rearward direction and contacts the base plate 210.

When the fixing member 810 is inserted into the first fixing area of the first supporting frame 450, the base plate 210, and the second fixing area of the second supporting frame 550, the cross fixing member 270 may be mounted on a lower side of the fixing area of the second supporting frame 550, and the second pack cover 700 may be mounted on a lower side of the cross fixing member 270.

In other words, the cross fixing member 270 may be mounted between the second pack cover 700 and the second supporting frame 550, acting as a component for supporting the second supporting frame 550.

The battery pack 100 may further include a frame fixing member 820 that is configured to fix the first supporting frame 450 and the second supporting frame 550 to the base plate 210 and is distinct from the fixing member 810.

The cross fixing member 270 may be configured to allow the frame fixing member 820 to be inserted thereinto and to support the second supporting frame 550.

When the cross fixing member 270 is mounted on a lower side of the second supporting frame 550, the frame fixing member 820 may be inserted into an area of the first supporting frame 450, which is spaced apart from an area, into which the fixing member 810 is inserted, in the leftward/rightward direction.

Then, the frame fixing member 820 may be inserted into a first fixing area of the first supporting frame 450, the base plate 210, a second fixing area of the second supporting frame 550, and the cross fixing member 270 to fix the cross fixing member 270 to the base plate 210. The frame fixing member 820 may be longer than the fixing member 810 in the upward/downward direction.

The battery pack 100 may further include a cover fixing member 830 for fixing the first pack cover 600 and the second pack cover 700 to the front member 220 and the rear member 230.

When the frame fixing member 820 is inserted into the cross fixing member 270, the cover fixing member 830 may be inserted into the second pack cover 700, the front member 220, and the rear member 230 through the lower area of the second pack cover 700.

When the second pack cover 700 is coupled to the front member 220 and the rear member 230, the first pack cover 600 may be positioned on an upper side of the first cell stack 400. The cover fixing member 830 may be inserted into the first pack cover 600, the front member 220, and the rear member 230 through an upper area of the first pack cover 600.

When the cover fixing member 830 is inserted into the first pack cover 600, the front member 220, and the rear member 230, the first pack cover 600 and the second pack cover 700 may be securely coupled to the front member 220 and the rear member 230, respectively.

Meanwhile, the first pack cover 600 and the second pack cover 700 may each include a cooling channel formed in an interior thereof and configured to cool the first cell stack 400 or the second cell stack 500. Furthermore, the base plate 210 may include a cooling channel formed in an interior thereof and configured to cool both the first cell stack 400 and the second cell stack 500.

According to this structure, because the base plate 210, with the cooling channel, is provided between the first cell stack 400 and the second cell stack 500, a thermal transfer between the first cell stack 400 and the second cell stack 500 may be delayed. In other words, heat transfer from any one of the first cell stack 400 and the second cell stack 500 to the other may be prevented, thereby preventing thermal runaway of the first (400) or second (500) cell stack.

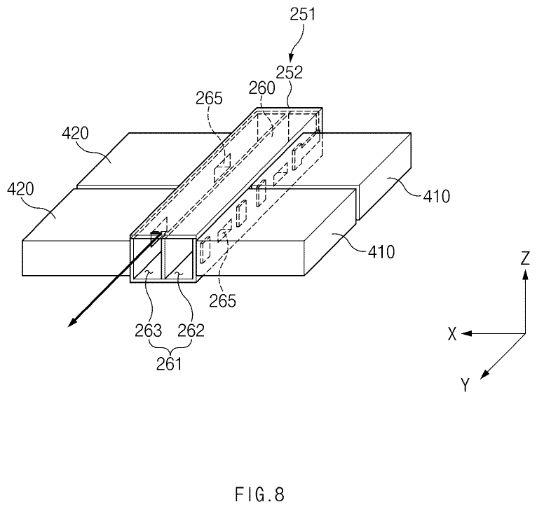

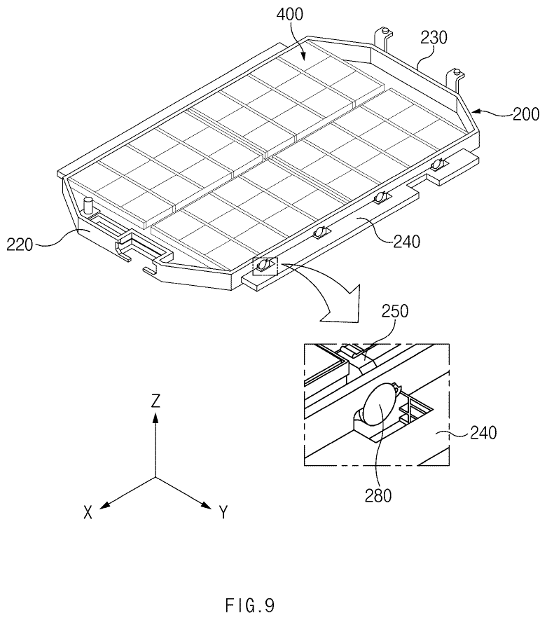

FIG. 8 is a schematic view illustrating the flow of flame or gas through a venting passage when a fire occurs in cell stacks that face each other with a crossing member being interposed therebetween according to an embodiment of the present disclosure. FIG. 9 is an enlarged view of a venting device that is mounted on a battery housing according to an embodiment of the present disclosure.

Referring to FIGS. 8 and 9, a (1-1)-th crossing member 252 may be provided between the (1-1)-th cell stack 410 and the (1-2)-th cell stack 420. The (1-1)-th crossing member 252 may include a venting 261 that the passage extends in leftward/rightward direction (the first direction) between the (1-1)-th cell stack 410 and the (1-2)-th cell stack 420, and communicates with the (1-1)-th cell stack 410 and the (1-2)-th cell stack 420, respectively.

The crossing member 252 may include a partition wall 260 that extends in the upward/downward direction to divide the venting passage 261 in the forward/rearward directions in an interior of the (1-1)-th crossing member 252. The partition wall 260 may extend in the leftward/rightward direction along the venting passage 261.

The venting passage 261 may include a first venting area 262 formed on a front side of the partition wall 260, and a second venting area 263 formed on a rear side of the partition wall 260. The first venting area 262 and the second venting area 263 may be separated from each other by the partition wall 260. The partition wall 260 may be formed of steel or mica to prevent heat transfer between fluids that flow through the first venting area 262 and the second venting area 263, respectively. Furthermore, the remaining area of the (1-1)-th crossing member 252 may be formed of aluminum (Al).

The first venting area 262 that is formed in an interior of the crossing member 252 may communicate with the (1-1)-th cell stack 410. The second venting area 263 that is formed in an interior of the (1-1)-th crossing member 252 may communicate with the (1-2)-th cell stack 420.

To achieve this, the (1-1)-th crossing member 252 may include a venting hole 265 that is configured for a flame or high-temperature gas generated from the (1-1)-th cell stack 410 or the (1-2)-th cell stack 420 to flows into the first venting area 262 or the second venting area 263. The venting holes 265 may be disposed on opposite sides of the forward/rearward direction of the (1-1)-th crossing member 252, respectively, and spaced apart from each other in the leftward/rightward direction.

Venting devices 280 may be provided at opposite ends of the first venting area 262 and the second venting area 263 in the leftward/rightward direction. The venting devices 280 may be mounted on the side members 240. Eight venting devices 280 may be provided, with four venting devices 280 on each of opposite sides of the battery housing 200 (see FIG. 1) in the leftward/rightward direction, but the present disclosure is not limited thereto. The venting devices 280 may communicate with venting passages 261 of the two crossing members 250 disposed in an upward/downward direction with the base plate 210 being interposed therebetween.

The venting devices 280 may prevent external materials from flowing into the battery housing 200 when the cells of the cell stack 300 operate normally. However, when a fire occurs in the cell, the venting device 280 may enable communication between the venting passage 261 and an outside of the battery housing 200 due to a flame or high-temperature gas pressure passing through the venting passage 261.

A description of the (1-1)-th cell stack 410, the (1-2)-th cell stack 420, and the (1-1)-th crossing member 252 illustrated in FIGS. 8 and 9 also applies to the (1-3)-th cell stack 430, the (1-4)-th cell stack 440, and the (1-2)-th crossing member 253.

Furthermore, a description of the (1-1)-th cell stack 410, the (1-2)-th cell stack 420, and the (1-1)-th crossing member 252 applies equally to the (2-1)-th cell stack 510, the (2-2)-th cell stack 520, and the (2-1)-th crossing member 255, and a description of the (2-3)-th cell stack 530, the (2-4)-th cell stack 540, and the (2-2)-th crossing member 256.

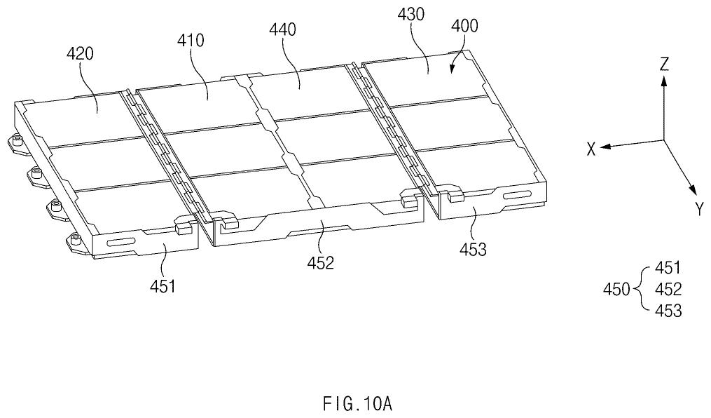

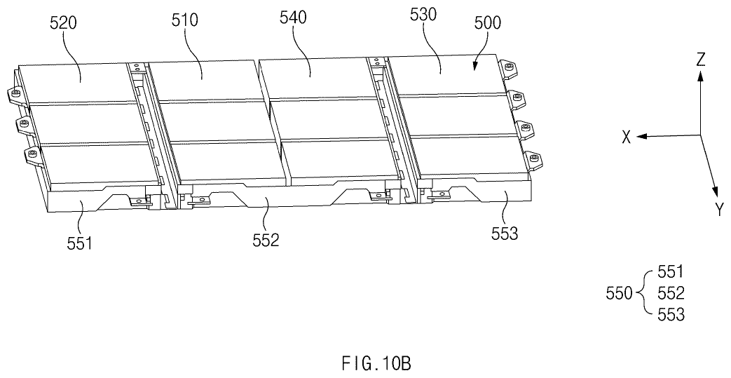

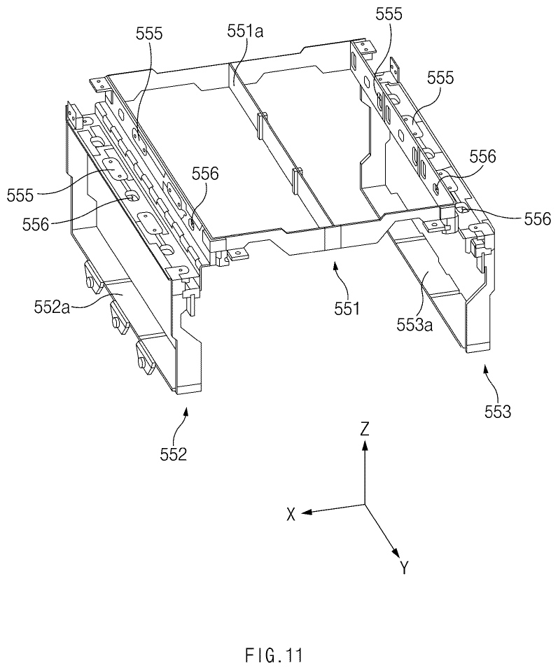

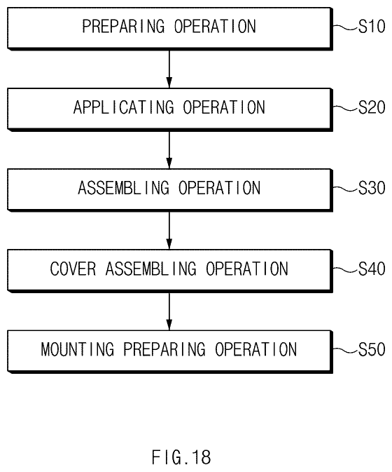

FIG. 10A is a perspective view of a first cell stack mounted on a first supporting frame according to an embodiment of the present disclosure. FIG. 10B is a perspective view of a second cell stack mounted on a second supporting frame according to an embodiment of the present disclosure. FIGS. 11 to 17 are perspective views illustrating a process of manufacturing a second cell stack according to an embodiment of the present disclosure. FIG. 18 is a flowchart of a method for manufacturing a cell stack according to an embodiment of the present disclosure.

Referring to FIGS. 10A and 10B, a first cell stack 400 may be supported by a first supporting frame 450. The second cell stack 500 may be supported by a second supporting frame 550.

The first supporting frame 450 may include a (1-1)-th support frame area 451 configured to support the (1-1)-th cell stack 410 and the (1-4)-th cell stack 440 together, a (1-2)-th support frame area 452 configured to support the (1-2)-th cell stack 420, and a (1-3)-th support frame area 453 configured to support the (1-3)-th cell stack 430.

The second supporting frame 550 may include a (2-1)-th supporting area 551 configured to support the (2-1)-th cell stack 510 and the (2-4)-th cell stack 540 together, a (2-2)-th support frame area 552 configured to support the (2-2)-th cell stack 520, and a (2-3)-th support frame area 553 configured to support the (2-3)-th cell stack 530.

The first and second supporting frames 450 and 550 may be configured such that a portion is rotatable with respect to another portion thereof. The (1-1)-th support frame area 451 and the (1-2)-th support frame area 452 may be coupled to each other to be rotatable, and the (1-1)-th support frame area 451 and the (1-3)-th support frame area 453 may be coupled to each other to be rotatable.

In more detail, the (1-2)-th support frame area 452 may be coupled to rotate about a central axis that extends in the first direction from the (1-1)-th support frame area 451. Furthermore, the (1-3)-th support frame area 453 may be coupled to rotate about the central axis that extends in the first direction from the (1-1)-th support frame area 451.

The first supporting frame 450 may be switched between a folding state, in which the (1-2)-th support frame area 452 and the (1-3)-th support frame area 453 form a specific angle with the (1-1)-th support frame area 451, and an unfolding state, in which the (1-2)-th support frame area 452 and the (1-3)-th support frame area 453 are unfolded from the (1-1)-th support frame area 451. When the folding state of the first supporting frame 450 is switched to the unfolding state, a rotation direction of the (1-2)-th support frame area 452 and a rotation direction of the (1-3)-th support frame area 453 may be opposite to each other.

For the switching structure of the first supporting frame 450, the description of the second supporting frame 550 is replaced with a description of the first supporting frame 450, except that it is symmetrical to the first supporting frame 450 in the upward/downward direction.

Hereinafter, the operations of assembling the (2-1)-th to (2-4)-th cell stacks 510, 520, 530, and 540 in the second supporting frame 550 will be described sequentially with reference to FIGS. 11 to 18. The description of the order in which the (1-1)-th to (1-4)-th cell stacks 410, 420, 430, and 440 are assembled in the first supporting frame 450 is analogous to a structure, in which the (2-1)-th to (2-4)-th cell stacks 510, 520, 530, and 540 are assembled in the second supporting frame 550.

Before the (2-1)-th to (2-4)-th cell stacks 510, 520, 530, and 540 are assembled in the supporting frame 550, the second supporting frame 550 may be positioned in a preparing operation S10 in a folding state. The preparing operation S10 involves preparing the first and second supporting frames 450 and 550 that are rotatable about the central axis, at least a portion of which extends in the first direction.

In other words, the (2-2)-th support frame area 552 and the (2-3)-th support frame area 553 may be positioned at a specific angle relative to the (2-1)-th support frame area 551.

The supporting frame 550 may include a hinge area 554 that is provided an area where the (2-2)-th support frame area 552 and the (2-1)-th support frame area 551 are coupled to each other or an area where the (2-3)-th support frame area 553 and the (2-1)-th support frame area 551 are coupled to each other. The (2-2)-th support frame area 552 and the (2-3)-th support frame area 553 may be coupled to the (2-1)-th support frame area 551 to be rotatable through the hinge area 554.

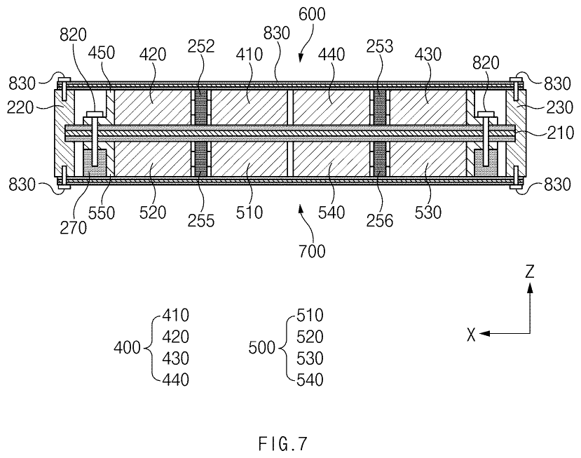

The hinge area 554 of the supporting frame 550 may be a portion where the (2-1)-th crossing member 255 (see FIG. 7) or the (2-2)-th crossing member 256 is provided. Furthermore, the hinge area 554 of the second supporting frame 550 may be a portion from which the lead parts 501 of the plurality of second cell stacks 500 protrude.

The second supporting frame 550 may include a busbar 555 that is electrically connected to a lead part 501 of the second cell stack 500, and a communication hole 556 that links the venting passage 261 provided in an interior of the second crossing member 254 (see FIG. 2) to the second cell stack 500. The communication hole 556 may be spaced apart from the busbar 555 in the leftward/rightward direction. The communication hole 556 may be located in an area of the second supporting frame 550 between the plurality of second cell stacks 500 and the second crossing member 254.

A plurality of busbars 555 may be configured to connect the lead parts 501 of two cells of the second cell stack 500, spaced apart in the leftward/rightward direction, respectively. Furthermore, a plurality of communication holes 556 may be provided to correspond to the cells of the second cell stack 500, arranged in the leftward/rightward direction.

An area where the busbar 555 and the lead part 501 of the second cell stack 500 are connected to each other, may be provided adjacent to the hinge area 554, and may be alternately positioned in the leftward/rightward direction.

A description of the structure of the second supporting frame 550 applies to the first supporting frame 450. The venting hole 265 of the first crossing member 251 illustrated in FIG. 8 may be formed in an area that faces the communication hole of the first supporting frame 450. Similarly, the venting hole of the second crossing member 254 (see FIG. 7) may be formed in an area that faces the communication hole 456 of the second supporting frame 550.

When the preparing operation S10 is completed, an applicating operation S20 may be performed on the second supporting frame 550. The applicating operation S20 may be an operation of applying an adhesive to one surface of the second supporting frame 550 to fix the second cell stack 500 while in a folded state.

The (2-2)-th and (2-3)-th support frame areas 552 and 553 may include one surface 552a and 553a located on an opposite side that is opposite to one side, on which the hinge area 554 is provided. Furthermore, the (2-1)-th support frame area 551 may include one surface 551a positioned between a pair of hinge areas 554 located in the forward/rearward direction.

The applicating operation S20 involves applying an adhesive to one surfaces 552a and 553a of the (2-2)-th and (2-3)-th support frame areas 552 and 553, and applying the adhesive to one surface 551a of the (2-1)-th support frame area 551.

When the adhesive is applied to the surfaces 552a and 553a of the (2-2)-th and (2-3)-th support frame areas 552 and 553, adhesion surfaces 552b and 553b may be formed on an opposite side that is opposite to the one side, where the second crossing members 254 of the (2-2)-th and (2-3)-th cell stacks 520 are positioned, to secure the (2-2)-th cell stack 530 onto the surfaces 552a and 553a of the (2-2)-th and (2-3)-th support frame areas 552 and 553.

Furthermore, when an adhesive is applied to one surface 551a of the (2-1)-th support frame area 551, an adhesion surface 551b positioned between the (2-1)-th cell stack 510 and the (2-4)-th cell stack 540, and for fixing the (2-1)-th cell stack 510 and the (2-4)-th cell stack 540 may be formed on one surface 551a of the (2-1)-th support frame area 551. The adhesion surface 551b of the (2-1)-th support frame area 551 may include both a surface that faces a front side and a surface that faces a rear side.

When the applicating operation S20 is completed, an assembling operation S30 of assembling the (2-1)-th to (2-4)-th cell stacks 510, 520, 530, and 540 in the second supporting frame 550 may be performed.

In the assembling operation S30, in the folding state of the second supporting frame 550, the lead parts 501 of the (2-1)-th to (2-4)-th cell stacks 510, 520, 530, and 540 are inserted into the second supporting frame 550 to face the hinge area 554, and the (2-1)-th to (2-4)-th cell stacks 510, 520, 530, and 540 are adhered to the respective adhesion surfaces 551b, 552b, and 553b, respectively.

In the assembling operation S30, when the (2-1)-th to (2-4)-th cell stacks 510, 520, 530, and 540 are adhered to the adhesion surfaces 551b, 552b, and 553b, respectively, the lead parts 501 of the (2-1)-th to (2-4)-th cell stacks 510, 520, 530, and 540 and the busbar 555 may be welded in an area adjacent to the central axis. Then, welding may be performed using a laser.

When the assembling operation S30 is completed, a cover assembling operation S40 may be performed on the second supporting frame 550 and the second cell stack 500. The cover assembling operation S40 may be an operation of assembling the busbar cover 557 on an opposite side to one side, where it connects to the lead part 501 of the busbar 555. Thus, the second supporting frame 550 may include a busbar cover 557 made of an electrically insulating material.

When the cover assembling operation S40 is completed, a mounting preparing operation S50 of switching to an unfolding state to unfold the second supporting frame 550 by rotating the (2-1)-th to (2-3)-th support frame areas 551, 552, and 553 about the central axis may be performed.

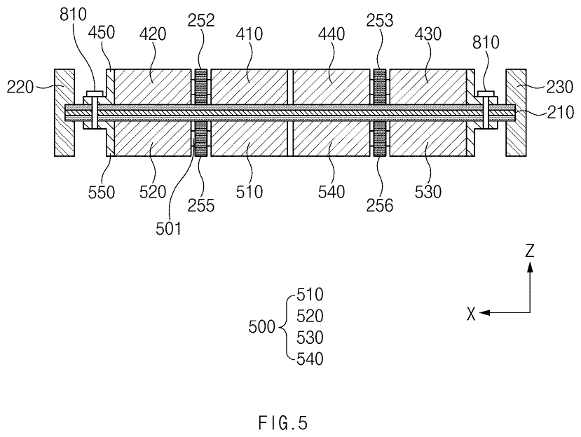

When the mounting preparing operation S50 is completed, as illustrated in FIG. 5, the second supporting frame 550 may be mounted in an interior of the accommodation space 201 (see FIG. 1). Thereafter, in the first and second cell stacks 400 and 500 according to the present disclosure, the assembly of the battery pack 100 may be completed through the above-described processes of FIGS. 3 to 7.

According to the above-described structure, even in a structure, in which the cell stack 300 is mounted in the form of a CTP in an interior of the battery pack 100, at least a portion of it may be rotated to allow the first and second supporting frames 450 and 550 to switch between the folding state and the unfolding state, so that the lead parts 401 and 501 of the first and second cell stacks 400 and 500 and the busbar 555 may be welded relatively easily. Accordingly, the manufacturing efficiency of the battery pack 100 may be improved.

Furthermore, the safety of the battery pack 100 may be improved as the thermal runaway of the battery pack 100 is prevented while the heat transfer between the first and second cell stacks 400 and 500 is delayed and the flame or the high-temperature gas is vent to the outside of the battery housing 200 while being prevented from flowing to the adjacent cell under a structure, in which the lead parts 401 and 501 of the first and second cell stacks 400 and 500 are oriented to protrude toward the crossing member 250.

This technology may prevent thermal runaway while allowing thermal delay in the cell stacks mounted on the battery housing, so that the safety of the battery pack may be improved.

In addition, the present disclosure may provide various effects directly or indirectly identified through this document.

The above description provides a basic exemplary overview of the technical spirits of the present disclosure, and an ordinary person in the art to which the present disclosure pertains may make various adjustments and modifications without departing from the essential characteristics of the present disclosure.

Therefore, the embodiments disclosed in the present disclosure are not intended to limit the technical spirits of the present disclosure but to describe them, and the scope of the technical spirits of the present disclosure is not limited by the embodiments. The protection scope of the present disclosure should be construed by the following claims, and all the technical spirits in the equivalent range should be considered within the scope of the present disclosure.

What is claimed is:

1. A battery pack comprising:
a battery housing including a crossing member that defines an accommodation space and extends in a first direction to divide the accommodation space, and a base plate that contacts the crossing member; and
a plurality of cell stacks mounted in the accommodation space to face each other in a second direction intersecting the first direction with the crossing member being interposed between them,
wherein the crossing member includes a venting passage coupled to the plurality of cell stacks and extending in the first direction, and a partition wall that extends in a third direction intersecting the second direction to divide the venting passage in the second direction, in an interior of the crossing member,
wherein the plurality of cell stacks comprise:
a plurality of first cell stacks disposed on one side of the base plate in the third direction; and
a plurality of second cell stacks disposed on an opposite side of the base plate in the third direction.

2. The battery pack of claim 1, further comprising:
a first supporting frame positioned to support the plurality of first cell stacks; and
a second supporting frame positioned to support the plurality of second cell stacks.

3. The battery pack of claim 2, wherein at least a partial area of the first supporting frame is positioned between the plurality of first cell stacks and the crossing member.

4. The battery pack of claim 3, wherein the first supporting frame includes a communication hole configured to provide communication between the plurality of first cell stacks and the venting passage, and
wherein the communication hole is located in an area of the first supporting frame between the plurality of first cell stacks and the crossing member.

5. The battery pack of claim 2, further comprising:
a frame fixing member configured to secure the first supporting frame and the second supporting frame to the base plate,
wherein the battery housing further includes a cross fixing member configured to receive the frame fixing member and to support the second supporting frame.

6. The battery pack of claim 5, further comprising:
a first pack cover disposed on one side of the plurality of first cell stacks in the third direction; and
a second pack cover disposed on an opposite side of the plurality of second cell stacks in the third direction,
wherein the cross fixing member is positioned between the second pack cover and the second supporting frame.

7. The battery pack of claim 5, wherein the first supporting frame includes:
a cell support area configured to support the plurality of first cell stacks; and
a fixing area protruding from the cell support area in the second direction, and the fixing area configured to receive the frame fixing member.

8. The battery pack of claim 1, wherein the crossing member comprises:
a first crossing member disposed on the one side of the base plate in the third direction, and positioned between the plurality of first cell stacks; and
a second crossing member disposed on the opposite side of the base plate in the third direction, and positioned between the plurality of second cell stacks.

9. The battery pack of claim 8, wherein the plurality of first cell stacks include a (1-1)-th cell stack disposed on one side of the first crossing member in the second direction, and a (1-2)-th cell stack disposed on an opposite side of the first crossing member in the second direction,
wherein the venting passage formed in an interior of the first crossing member includes:
a first venting area provided on one side of the partition wall in the second direction, and a second venting area provided on an opposite of the partition wall in the second direction, and
wherein the first venting area is communicated with the (1-1)-th cell stack, and the second venting area is communicated with the (1-2)-th cell stack.

10. The battery pack of claim 9, further comprising:
a first supporting frame configured to support the plurality of first cell stacks, and a second supporting frame configured to support the plurality of second cell stacks,
wherein the first supporting frame includes a (1-1)-th support frame area supporting the (1-1)-th cell stack, and a (1-2)-th support frame area supporting the (1-2)-th cell stack, and
wherein the (1-1) supporting frame includes a communication hole configured to provide communication between the (1-1)-th cell stack and a first venting passage, and
wherein the first crossing member includes a venting hole formed in an area facing the communication hole.

11. The battery pack of claim 1, wherein the base plate includes a cooling channel formed in an interior thereof.

12. The battery pack of claim 8, wherein the base plate is coupled to both the first crossing member and the second crossing member to secure the first crossing member and the second crossing member in position.

13. The battery pack of claim 6, wherein at least one of the first pack cover or the second pack cover includes a cooling channel formed within its interior.

14. The battery pack of claim 6, wherein the battery housing includes a front member disposed on one side of the accommodation space in the second direction or a rear member disposed on an opposite side of the accommodation space in the second direction, and
wherein the front member or the rear member is coupled to the first pack cover and the second pack cover.

15. The battery pack of claim 1, wherein the partition wall is formed of steel or mica, and
wherein a remaining area of the crossing member, except for the partition wall, is formed of aluminum (Al).

16. The battery pack of claim 1, further comprising:
a venting device mounted on one end of the venting passage in the first direction.
